(19) United States
(12) Patent Application Publication
(10) Pub. No.: US 2024/0337146 A1
(43) Pub. Date: Oct. 10, 2024

(54) CHARGING INTERFACE DEVICE OF AN ELECTRIC VEHICLE WITH A TRACTION BATTERY

(71) Applicant: Dr. Ing. h.c. F. Porsche Aktiengesellschaft, Stuttgart (DE)

(72) Inventor: Riccardo Bauer, Owen (DE)

(73) Assignee: Dr. Ing. h.c. F. Porsche Aktiengesellschaft, Stuttgart (DE)

(21) Appl. No.: 18/600,822

(22) Filed: Mar. 11, 2024

(30) Foreign Application Priority Data
Apr. 4, 2023 (DE) 10 2023 108 534.4

(51) Int. Cl. E05F 15/603; B60L 50/16

(52) U.S. Cl. CPC E05F 15/603; B60L 50/16; E05Y 2900/534

(57) ABSTRACT

A charging interface device of an electric vehicle having a traction battery including a charging interface for receiving a plug of a charging cable for charging the traction battery. A charging port, into which the charging interface is arranged, is releasable or closable with the aid of an interface cover. The interface cover is configured to be rollable.

### CROSS-REFERENCE TO RELATED APPLICATION

This application claims priority to German Patent Application No. 10 2023 108 534.4, filed Apr. 4, 2023, the content of such application being incorporated by reference herein in its entirety.

### FIELD OF THE INVENTION

The invention relates to a charging interface device of an electric vehicle having a traction battery.

### BACKGROUND OF THE INVENTION

Electric vehicles having a traction battery are sufficiently known. The traction battery serves to propel the electric vehicle in the form of an electric motor and requires a charging interface in a body of the electric vehicle, via which said traction battery can be charged with energy in the form of a power flow. The charging interface is to be equipped with a charging interface cover for functional safety.

A charging interface for a vehicle is known from document DE 10 2018 204 840 A1, which is incorporated by reference herein, which is covered by a rollable gate or rolling shutter. Publications CN 110816333 A, CN 210734316 U and CN 211281222 U, which are incorporated by reference herein, refer to a charging socket cover with a rolling device.

The document DE 10 2019 128 509 A1, which is incorporated by reference herein, discloses a locking system of a charging interface having a slat which can be moved to release a high-voltage connection.

### SUMMARY OF THE INVENTION

Described herein is a compact charging interface device of an electric vehicle, having a traction battery.

A charging interface device of an electric vehicle having a traction battery according to aspect of the invention comprises a charging interface for receiving a plug of a charging cable for charging the traction battery, and a charging port into which the charging interface is arranged, wherein the charging port is releasable or closable with the aid of an interface cover. According to aspect of the invention, the interface cover is configured to be rollable. That is to say, the interface cover can be rolled up or wound around an axis of rotation, similar to a roller blind. The advantage is the realization of a charging interface device with reduced installation space. That is to say, the charging port and the interface cover in particular can be kept relatively small and the interface cover requires little space when rolled up. This means that the required and therefore available installation space when the charging port is opened is reduced with the charging interface device according to aspect of the invention.

For example, the interface cover could be configured in the form of a thin one-piece rollable element. Preferably, the interface cover is configured in the form of a plurality of slats, so there is the possibility of improved rolling up or down, or winding and unwinding.

Advantageously, the slats are movably connected to one another. That is to say, the slats can be moved relative to one another and thus can be pivoted relative to one another around a slat axis, which is configured at least parallel to the axis of rotation.

The slats are connected to each other like chain links, which means that they can advantageously be rolled up or down, or wound or unwound.

The interface cover may be rollable laterally or downwardly or upwardly. In other words, it may be rolled up or down along a longitudinal axis or a transverse axis of the body, or it may be rolled up or down along a vertical axis of the body.

For secure operation of the charging interface device, the interface cover is rollable around a charging interface shaft. This means that a shaft (the charging interface shaft) is arranged in the charging interface device and the interface cover can be rolled up or down around said charging interface shaft.

To further improve operation, the interface cover is connected to the charging interface shaft. In this case, the charging interface shaft is rotatably mounted in the charging interface device, and with the aid of the connection between the interface cover and the charging interface shaft, the interface cover is rolled up or down when the charging interface shaft rotates, depending on the direction of rotation of the charging interface shaft.

For simplified operation of the charging interface device, it has a drive, preferably an electric drive, to move the interface cover.

With the aid of the charging interface device according to aspect of the invention, a particularly compact interface cover consisting of a plurality of rollable slats with good operability of the charging interface is realized.

### BRIEF DESCRIPTION OF THE DRAWINGS

Additional advantages, features, and details of the invention arise from the following description of preferred exemplary embodiments, as well as with reference to the drawings. The features and feature combinations specified hereinabove in the description, as well as the features and feature combinations mentioned hereinafter in the description of the drawings and/or shown alone in the drawings, can be used not only in the respectively specified combination, but also in other combinations, or on their own, without departing from the scope of the invention. Identical or functionally identical elements are assigned identical reference signs. The figures show:

FIG. 1 shows a section of a side view of a body of an electric vehicle having a traction battery with a charging interface device according to the prior art in a closed position,

FIG. 2 shows a section of a charging interface device of the electric vehicle according to aspect of the invention with the traction battery in the closed position, and

FIG. 3 shows a section of a charging interface device of the electric vehicle according to aspect of the invention with the traction battery in an open position.

### DETAILED DESCRIPTION OF THE INVENTION

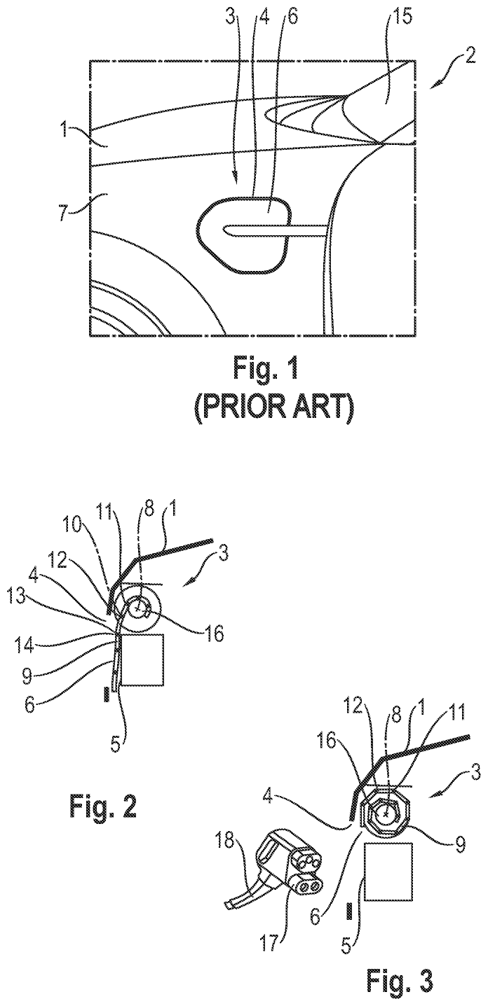

FIG. 1 shows a section of a side view of a body 1 of an electric vehicle 2 having a traction battery, which is not shown in greater detail, in a closed position of a charging interface device 3 according to the prior art, the body 1 has a charging port 4 with a charging interface 5, which is releasable or closable with the aid of a charging interface cover 6. The electric vehicle 2 can be designed in the form of a solely battery-powered motor vehicle, or it can be designed in the form of a so-called hybrid vehicle, which can be operated either with the aid of an internal combustion engine or an electric motor.

The charging port 4 is configured on a front side part 7 of the body 1, although it could also be configured on a rear side part or on a front part or a rear part of the body 1. Accordingly, the interface cover 6 is arranged in the body 1.

The charging interface device 3 according to aspect of the invention is configured as shown in FIGS. 2 and 3, wherein it is illustrated in FIG. 2 in its closed position and in FIG. 3 in its open position, in which it releases the charging interface 5.

The interface cover 6 is configured to be rollable. That is to say, it is configured to be rolled up or down around an axis of rotation 8, wherein it has an increasing or decreasing circumference extending in the radial direction from the axis of rotation 8. In other words, the interface cover 6 is windable around the axis of rotation 8.

The interface cover 6 consists of a plurality of slats 9, which are movably connected to each other. In other words, each slat 9 is pivotable relative to the adjacently arranged slat 9 around a slat axis 10.

The slats 9 are connected to each other like chain links. In a simplest case, for example, openings would be configured in the area of an upper slat edge 11 of the slat 9 and a lower slat edge 12 of the slat 9, into which eyelets are inserted, wherein each eyelet connects two slats 9 to each other.

In the present exemplary embodiment, the slat axis 10 extends along the axis of rotation 8 and is thus configured parallel to it. A slat rod 13 extends coaxially with the slat axis 10, which is inserted into a receiving opening 14 of the slat 9. The adjacent slat edges 11, 12 are shaped complementarily to each other so that both slats 9 are connected to the slat rod 13. In other words, the upper edge 11 of the slat 9 is opposite the lower edge 12 of the adjacent slat 9 and both slats 9 are connected to the slat rod 13.

The interface cover 6 is upwardly rollable in the present exemplary embodiment. It could also be configured to be laterally or downwardly rollable. In this context, rollable means that the interface cover 6 can be rolled up towards a windscreen 15 of the body 1.

The charging interface device 3 according to aspect of the invention comprises a charging interface shaft 16 around which the interface cover 6 is rollable. The interface cover 6 is operatively connected to the charging interface shaft 16. It is preferably positively connected to the charging interface shaft 16. Thus, the interface cover 6 is rolled up or down when the charging interface shaft 16 is rotated.

When the interface cover 6 is rolled up as illustrated in FIG. 3, the charging interface 5 is released and a plug 17 of a charging cable 18 can be connected to the charging interface 5.

Advantageously, the charging interface device 3 for moving the interface cover 6 comprises a drive not shown in detail, which is an electric drive.

The charging interface device 3 further comprises a charging cradle not shown in detail, comprising the charging interface 5. The charging cradle is designed to be fixed to the body, wherein the charging port 4 is configured in the charging cradle, and can be opened or closed with the aid of the interface cover 6.

### LIST OF REFERENCE NUMBERS

1 Body
2 Electric vehicle
3 Loading interface device
4 Charging port
Charging interface
6 Interface cover
7 Front side part
8 Axis of rotation
9 Slat
Slat axis
11 Top slat edge
12 Bottom slat edge
13 Slat rod
14 Receiving opening
Windshield
16 Charging interface shaft
17 Plug
18 Charging cable

What is claimed is:

1. A charging interface device for an electric vehicle having a traction battery, said charging interface device comprising:
a charging interface for receiving a plug of a charging cable for charging the traction battery, and
a charging opening in which the charging interface is arranged,
wherein the charging opening is releasable or closable with the aid of a rollable interface cover.

2. The charging interface device according to claim 1, wherein the interface cover comprises a plurality of slats.

3. The charging interface device according to claim 2, wherein the slats are movably connected to each other.

4. The charging interface device according to claim 2, wherein the slats are connected to each other in a chain link manner.

5. The charging interface device according to claim 1, wherein the interface cover is laterally rollable, downwardly rollable or upwardly rollable.

6. The charging interface device according to claim 1, wherein the interface cover is rollable around a charging interface shaft.

7. The charging interface device according to claim 6, wherein the interface cover is connected to the charging interface shaft.

8. The charging interface device according to claim 1, wherein the charging interface device for moving the interface cover includes a drive.

9. The charging interface device according to claim 8, wherein the drive is an electric drive.
